(19) United States
(12) Patent Application Publication
(10) Pub. No.: US 2003/0163817 A1
(43) Pub. Date: Aug. 28, 2003

(54) Apparatus for controlling preference channels and method thereof, audience rating survey system using the same, and method thereof

(75) Inventor: Hee-chul Han, Suwon-si (KR)

Correspondence Address: SUGHRUE MION, PLLC, 2100 Pennsylvania Avenue, NW, Washington, DC, 20037-3213, US

(73) Assignee: SAMSUNG ELECTRONICS CO., LTD.

(21) Appl. No.: 10/256,235

(22) Filed: Sep. 27, 2002

(30) Foreign Application Priority Data
Feb. 23, 2002 (KR) 2002-9742

(51) Int. Cl. H04N 5/445; H04N 7/16

(52) U.S. Cl. 725/46; 725/145; 725/146

(57) ABSTRACT

Apparatus for controlling preference channels and a method thereof, an audience rating survey system using the same and a method thereof, in which information related to channels preferred by a viewer is automatically totaled according to day and time to decide ranking and channels are selected and an on-line audience rating survey is performed on the basis of information related to preference channels, are provided. Accordingly, a user checks information related to preference channels according to day and time, registers the information according to rankings of the preference channels, uses the registered information related to preference channels when selecting channels, and makes an on-line audience rating survey of the registered information related to preference channels. Thus, the user can easily search for a desired channel. In addition, preference channels are searched for immediately when turning on a TV, thereby the most preferred channel is automatically selected.

### BACKGROUND OF THE INVENTION

1. Field of the Invention

The present invention relates to an apparatus for controlling channels and a method thereof, and more particularly, to an apparatus for controlling preference channels and a method thereof, an audience rating survey system using the same and method thereof, in which information related to channels preferred by a viewer is automatically totaled according to day and time to decide ranking, and channels are selected and an on-line audience rating survey is performed on the basis of the information related to preference channels. The present application is based on Korean Patent Application No. 2002-9742, which is incorporated herein by reference.

2. Description of the Related Art

In the prior art, when a viewer wants to change from one channel to another channel, the viewer selects a desired channel by pushing a CHANNEL UP/DOWN key or by inputting a predetermined channel number. However, as a digital broadcasting system has emerged, and the number of broadcasting channels has more rapidly increased than in an analog broadcasting system, there are many inconveniences including taking a substantial amount of time for a viewer to check and select a desired channel using a CHANNEL UP/DOWN key, and the viewer having to input many keys.

In order to remove these inconveniences of selecting channels, a preference channel registration technology in which preference channels are registered and channels are selected using registered channels has been developed. However, in the preference channel registration technology, the viewer registers preference channels manually by manipulating keys such as remote control keys, to allow the viewer to use information related to registered preference channels when selecting channels.

However, in the preference channel registration technology, even though preference channels vary according to day and time, only several preference channels can be indiscriminately registered. Thus, there are limitations in utilizing information related to registered preference channels when the viewer selects channels. Also, there are inconveniences in which the viewer must input keys several times so as to register preference channels.

An audience rating survey has been made by an audience rating survey institution by inquiring about the most preferred channels from a small sample of homes and totaling the results of the inquisition. As a result, the reliability of totals of the audience rating is slightly lowered, and it takes much time and effort to total an audience rating.

### SUMMARY OF THE INVENTION

To solve the above problems, it is an object of the present invention to provide an apparatus for controlling preference channels and a method thereof, an audience rating survey system using the same and a method thereof, in which information related to channels preferred by a viewer is analyzed according to day and time and is registered according to a channel ranking, and channels are selected and an audience rating survey is performed on the basis of registered information related to the preference channels.

Accordingly, to achieve the above object, according to one aspect of the present invention, there is provided an apparatus for controlling preference channels. The apparatus includes a timer circuit for performing an operation on information related to current day and time and outputting the information, a memory for storing a preference channel information table that is totaled according to day and time, and a controlling portion for classifying information related to the number of selected and viewed channels and information related to the number of preference channels based on output information of the timer circuit according to day and time, adding these information to channel points of a corresponding channel number of the preference channel information table that is stored in the memory, determining the ranking of preferences of channel numbers corresponding to values that are added according to day and time and performing a predetermined process of controlling channels using information related to the ranking of the preference channel numbers that is stored in the preference channel information table of the memory.

In order to achieve, the above object, according to another aspect of the present invention, there is provided a method for controlling preference channels. The method includes the steps of (a) performing an operation on information related to current day and time after channels are selected, and determining whether a same channel is maintained consecutively for more than a critical time, (b) adding up a unit point to points of preference of selected channels at current day and time from a preference channel information table in which points of channel preference of the number of a viewed channel according to day and time are stored in a case where the same channel is maintained consecutively for more than the critical time as a result of determination in the step (a), (c) determining rankings of the number of preference channels according to the added up preference points, and (d) transmitting and receiving data having determined rankings of the preference channel numbers via an external communication network.

In order to achieve the above object, according to another aspect of the present invention, there is provided an audience rating survey system. The system includes a communication module unit for being connected to a network with an apparatus for controlling preference channels which performs a predetermined process of controlling channels and performing data communication, a database for storing information related to members, preference channels, the result of analysis of audience ratings, and an audience rating report, which is collected through data communication, and a control module unit for controlling the communication module unit and the database, collecting information related to preference channels according to day and time from TVs that are connected to the network, analyzing audience ratings using the collected information related to preference channels and performing a process of creating an audience rating report using the analyzed information related to audience ratings.

In order to achieve the above object, according to another aspect of the present invention, there is provided a method for making an audience rating survey. The method includes the steps of (a) performing data communication with TVs that are connected to a network and collecting information related to preference channels, (b) analyzing the information related to preference channels that is collected in the step (a) and performing audience rating evaluation according to day and time on the basis of statistics, and (c) creating an audience rating report using the result of audience rating evaluation that is performed in the step (b).

### BRIEF DESCRIPTION OF THE DRAWINGS

The above object and advantages of the present invention will become more apparent by describing in detail preferred embodiments thereof with reference to the attached drawings in which:

FIG. 1 illustrates the structure of a television including an apparatus for controlling preference channels according to the present invention;

FIG. 2 illustrates the structure of an audience rating survey system according to the present invention;

FIG. 3 is a flow chart illustrating a process of registering preference channels according to the present invention;

FIG. 4 is a flow chart illustrating a process of automatically selecting preference channels according to the present invention when a TV power is turned on;

FIG. 5 is a flow chart illustrating a process of automatically searching for preference channels according to the present invention;

FIG. 6 is a flow chart illustrating a method for making an audience rating survey according to the present invention;

FIG. 7 illustrates the structure of a preference channel information table according to the present invention; and

FIG. 8 illustrates an on screen display (OSD) output specification of preference channels using electronic program guide (EPG) information according to an embodiment of the present invention.

### DETAILED DESCRIPTION OF THE INVENTION

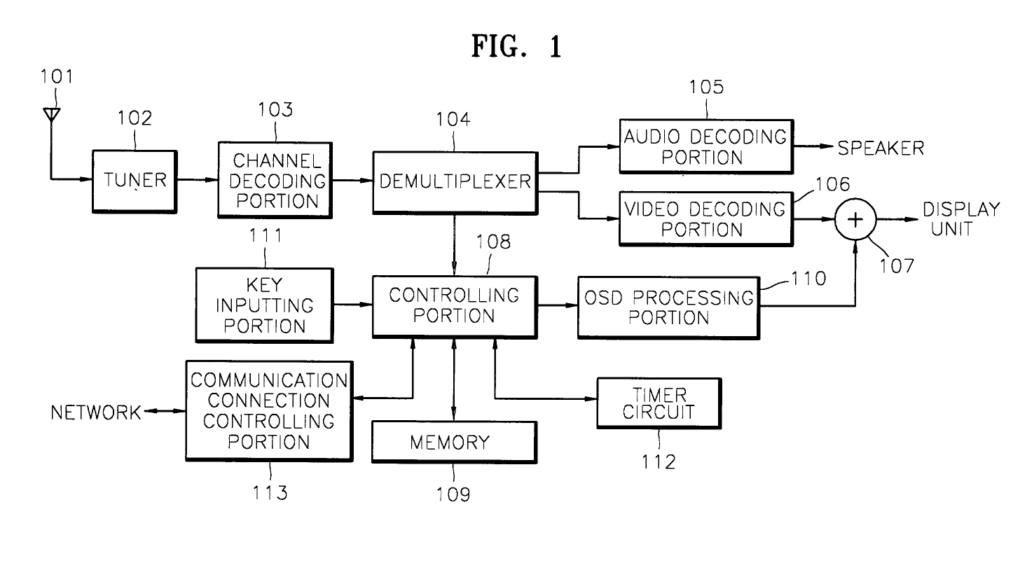

As shown in FIG. 1, a television (TV) including an apparatus for controlling preference channels according to the present invention includes an antenna 101, a tuner 102, a channel decoding portion 103, a demultiplexer 104, an audio decoding portion 105, a video decoding portion 106, a mixer 107, a controlling portion 108, a memory 109, an on screen display (OSD) processing portion 110, a key inputting portion 111, a timer circuit 112, and a communication connection controlling portion 113.

First, the basic operation of the TV will be described briefly below.

In a case where a viewer selects a desired channel after a TV power is turned on using the key button of the key inputting portion 111, the tuner 102 selects and outputs only a broadcasting signal from a channel that is set by a user, among broadcasting signals that are received from the antenna 101 or an input terminal (not shown). Then, the channel decoding portion 103 restores a digital signal that is detected from the broadcasting signal of a selected channel, in units of packets and outputs the digital signal to the demultiplexer 104. The demultiplexer 104 classifies audio data, video data, and additional information data including an electronic program guide (EPG) information from the restored data in units of packets into an individual bit row, respectively, and outputs the audio data, the video data, and the additional information data.

Then, the audio data is decoded by the audio decoding portion 105, and then is converted into an analog signal and finally, is output to a speaker.

The video data is decoded and error corrected by the video decoding portion 106. Then, the decoded video signal is mixed with a signal that is on screen display (OSD)-processed by the mixer 107 and is finally output to a display unit.

The timer circuit 112 performs the counting operation of an internal clock and creates information related to time, day, and date.

The communication connection controlling portion 113 modulates and demodulates signals to perform data communication via a network. That is, the communication connection controlling portion 113 transmits and receives information related to ranking of the number of preference channels that is stored in a preference channel information table of the memory 109, via a communication line.

Hereinafter, the operation of registering preference channels according to the present invention and the operation of selecting channels using the registered preference channels according to the present invention will be described in detail below.

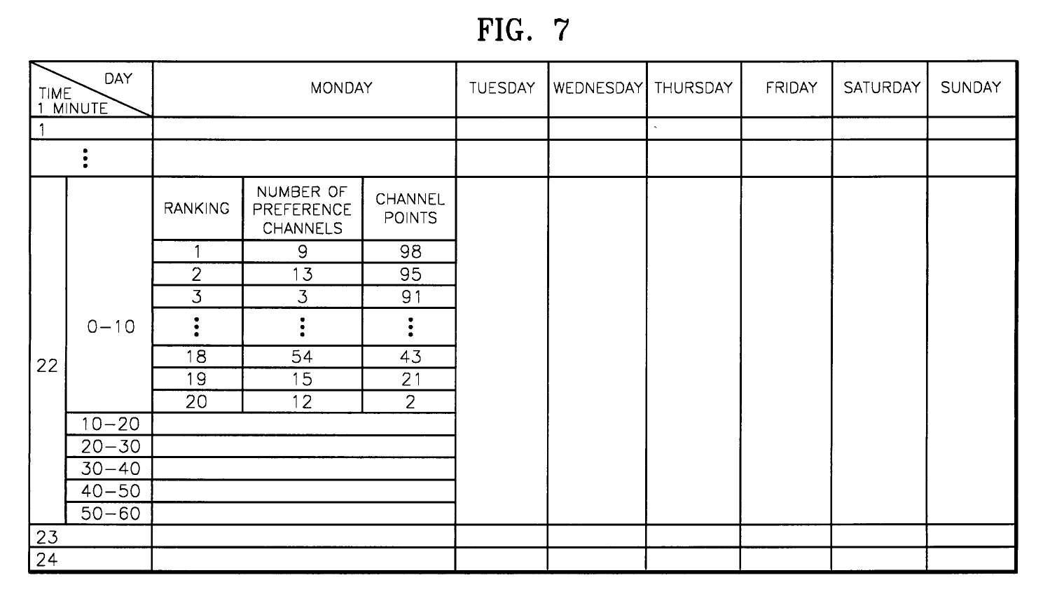

The preference channel information table is stored in the memory 109, and as shown in FIG. 7, information related to preference channels that are popular according to day and time is stored in the preference channel information table according to ranking.

The controlling portion 108 analyzes information related to the number of selected and viewed channels and output information of the timer circuit 112, adds the information to channel points of a corresponding channel number of the preference channel information table that is stored in the memory 109, determines the ranking of preference of channel numbers corresponding to values that are added according to day and time and selects preference channels on predetermined conditions using information related to the ranking of the preference channel numbers that is stored in the preference channel information table.

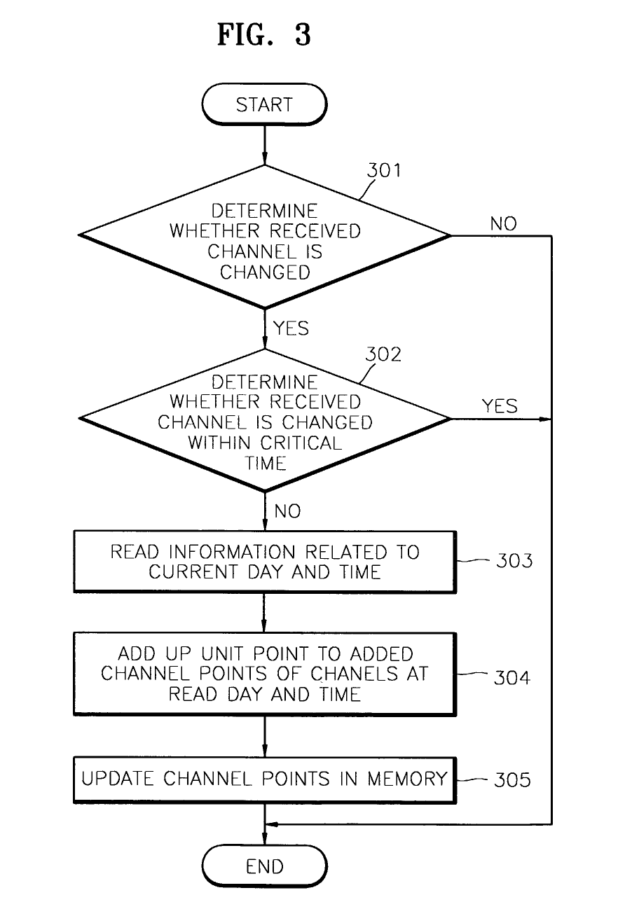

Next, a process of registering preference channels according to the present invention shown in FIG. 3 will be described with reference to FIG. 1 in detail.

In step 301, the controlling portion 108 determines whether a command for changing a received channel is input by the key inputting portion 111.

In step 302, in a case where the command for changing a received channel is input as a result of determination in step 301, it is determined whether the command for changing a received channel is input within a critical time. Here, the critical time means a minimum viewing time in which it can be determined that a selected channel is viewed. A user can set the critical time by manipulating the key inputting portion 111, and in a case where there is no input for setting a critical time, as an example, ten minutes can be set as a default.

In a case where the user views a predetermined channel without changing a channel for more than the critical time as a result of determination in step 302, information related to current day and time is read from the timer circuit 112 in step 303, and then, in step 304, a unit point is added up to the added channel points of channels that are viewed according to day and time from the preference channel information table.

In step 305, the channel points are updated in the preference channel information table that is stored in the memory 109.

As an example, in a case where a time for viewing a present viewing channel when the user views TV broadcasting is longer than the critical time, a unit point 1 is added to the point of the viewing channel according to day and time of the preference channel information table. That is, in a case where the user views a thirteenth channel for a longer time than the critical time at 0-10 minutes, 22:00, Monday in the preference channel information table shown in FIG. 7, 1 point is added to a channel point 95 of the thirteenth channel, which is thereby updated to 96 points. After the channel point is updated, the channel point column is rearranged according to the channel points and the ranking of the preference channels. That is, in a case where the user views the thirteenth channel having a second ranking at 0-10 minutes, 22:00, Monday, four more times than a ninth channel having a first ranking in the preference channel information table, the total points of the thirteenth channel becomes 99, and thus, the thirteenth channel changes to a first ranking, and the ninth channel having a first ranking changes to a second ranking.

The frequency of a viewed channel can be totaled according to day and time by performing the above steps.

In another embodiment of the present invention, step 301 may be omitted, and the method beginning from step 302 may be performed. In this case, the frequency of the channels that are viewed without changing channels more than for the critical time is added and totaled to be updated to the preference channel information table regardless of changing channels.

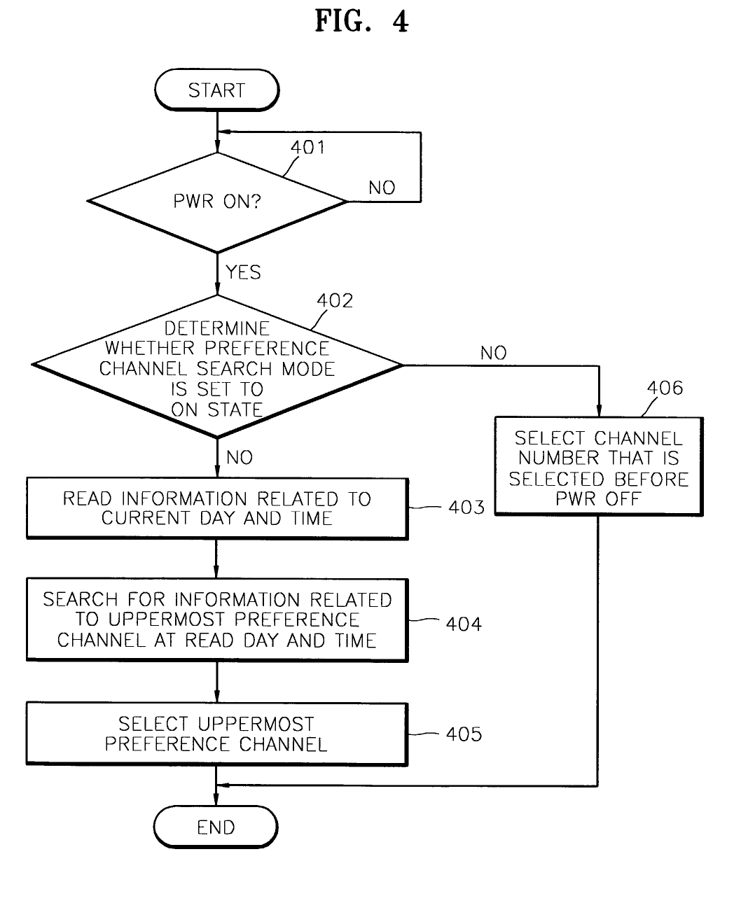

Next, a process of automatically selecting preference channels that is performed by the controlling portion 108 when the TV power is turned on will be described with reference to FIG. 4 in detail.

In step 401, the controlling portion 108 determines whether a POWER ON command is input by the key inputting portion 111.

In step 402, in a case where the POWER ON command is input as a result of determination in step 401, it is determined whether a preference channel search mode is turned on. The user can selectively set on/off of the preference channel search mode and can permanently set the preference channel search mode to an ON state as a design specification. In a case where the preference channel search mode is fixed in an ON state, steps 402 and 406 are omitted.

In a case where the preference channel search mode is set to an ON state as a result of the determination in step 402, information related to current day and time is read from the timer circuit 112 in step 403, and then, in step 404, a channel number having an uppermost ranking of the most channel points at the current day and time from the preference channel information table is searched for.

In step 405, the channel of a broadcasting signal that is received by automatically changing a channel number that is previously set into the uppermost preference channel number that is searched for in step 404, is selected.

In a case where the preference channel search mode is not set to an ON state as a result of the determination in step 402, in step 406, a channel number that is selected and stored before the TV power is turned off is selected.

The most preferred channel at the current day and time may be automatically searched for and viewed by user's selection when the TV power is turned on, by performing the above steps.

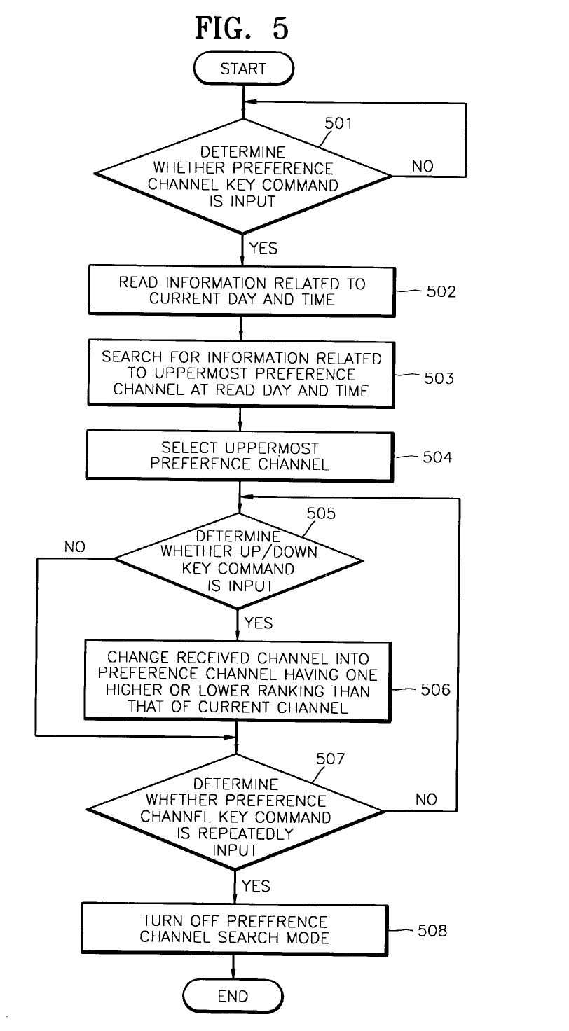

Next, a process of automatically searching for preference channels that is performed by controlling the controlling portion 108 will be described with reference to FIG. 5 in detail.

In step 501, the controlling portion 108 determines whether a preference channel key command is input by manipulating the key inputting portion 111.

In a case where the preference channel key command is input as a result of the determination in step 501, information related to current day and time is read from the timer circuit 112 in step 502. Then, in step 503, a channel number having an uppermost ranking of the most channel points at the current day and time from the preference channel information table is searched for.

In step 504, a received channel is changed into the uppermost preference channel number that is searched for in step 503, and then the uppermost preference channel number is selected.

Additionally, in step 505, it is determined whether an UP/DOWN key command is input in a state where the preference channel key command is input.

In step 506, in a case where the UP key command is input as a result of the determination in step 505, the received channel is changed into a preference channel having a ranking of one higher than that of a current channel, and in a case where the DOWN key command is input, the received channel is changed into a preference channel having a ranking of one lower than that of the current channel. However, in a case where the current channel is the uppermost preference channel, and the UP key command is input, the current channel is maintained. In the same manner, in a case where the current channel is the lowermost channel, and the DOWN key command is input, the current channel is maintained.

Likewise, using the preference channel key and the UP/DOWN key, a viewer can easily see preference channels according to day and time when changing channels.

In step 507, it is determined whether the preference channel key command is repeatedly input, and in a case where the preference channel key command is repeatedly input, in step 508, the preference channel search mode is turned off, and channels are selected in a numerical channel order.

In the embodiment of the present invention, in a case where the preference channel key command is repeatedly input, the preference channel search mode is released, but as occasion demands, an additional preference channel search mode release key may be installed at the key inputting portion 111.

In the embodiment of the present invention shown in FIG. 5, channels are automatically selected to a priority preference channel by the preference channel key command, but in another embodiment of the present invention, in a case where the preference channel key command is input, channels may be not changed, and simultaneously only the list of a preference channel ranking may be displayed on a screen. That is, in a case where the UP/DOWN button is pushed in a state where the preference channel button is pushed, channels having from a first ranking to a predetermined ranking (i.e., twentieth ranking) from the preference channel information table that is defined according to current day and time, may be displayed on a screen.

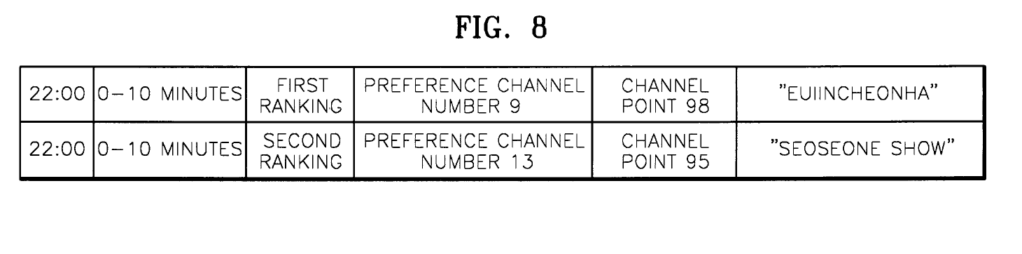

In addition, the user can see the preference channel information table from an OSD menu and can read the EPG information of the preference channels at a corresponding time beside points of the preference channel information table, and thus, as shown in FIG. 8, the channels may be displayed on a screen.

Next, an on-line audience rating survey system and method thereof using information that is registered in the preference channel information table will be described below.

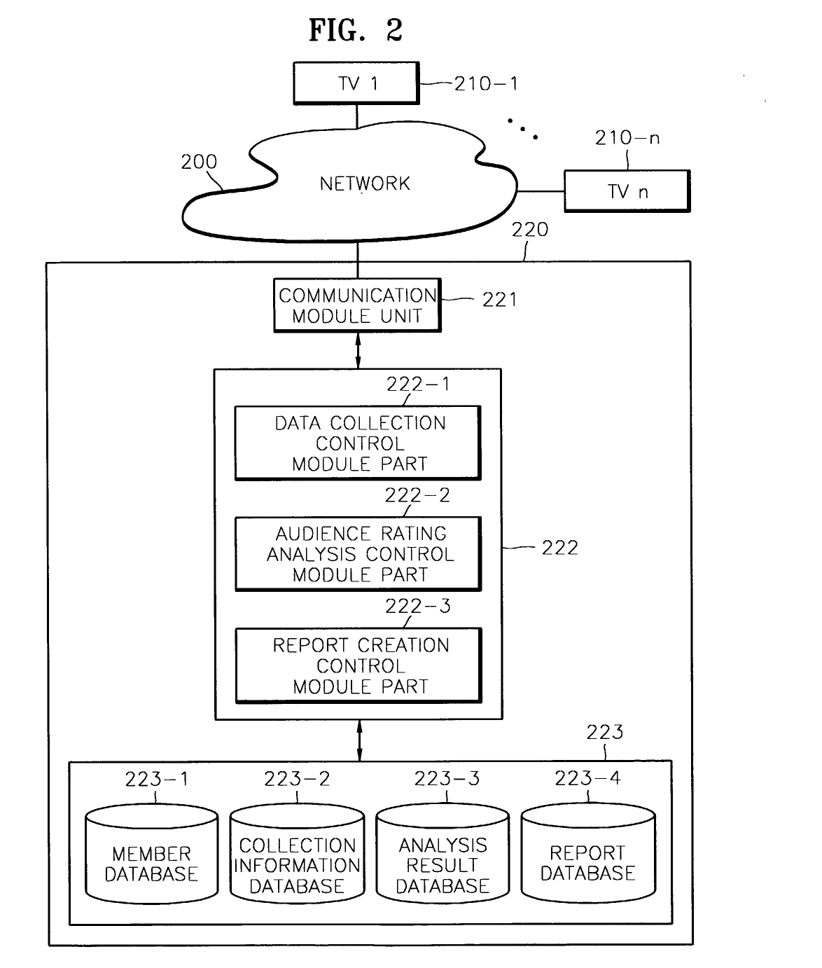

As shown in FIG. 2, an audience rating survey system according to the present invention includes a network 200, TV1˜TVn (210-1˜210-n), and an audience rating survey server 220.

As an example, Internet, which is a communication network for connecting computers to webs worldwide, may be used as the network 200. In this case, in order to use Internet services from the TV1˜TVn (210-1˜210-n) and the audience rating survey server 220, an Internet protocol (IP) address is allocated using a point to point protocol (PPP), which is software for Internet connection, and Internet services may be used via a world wide web (WWW) browser using the IP address. In this case, in order to use WWW services, desired information is acquired by being connected to the server of a desired web site due to the operation of a web browser such as Netscape Navigator and Microsoft Internet Explorer. Of course, in a case where an exclusive line is used, Internet services may be acquired using a TCP/IP protocol instead of the PPP.

As a result, the TV and the audience rating survey server 220 can perform data communication via the network 200.

Specifically, the audience rating survey server 220 includes a communication module unit 221, a control module unit 222, and a database 223.

Hardware and software for transmitting/receiving information related to an audience rating with TV1˜TVn (210-1 ˜ 210-n) that are connected to the network 200 are built in the communication module unit 221.

The control module unit 222 includes a data collection control module part 222-1, an audience analysis control module part 222-2, and a report creation control module part 222-3. The data collection control module part 222-1 collects information related to preference channels that are divided according to day and time from the TVs connected to the network 200 and stores the information in a collection information database 223-2. The audience analysis control module part 222-2 analyzes an audience rating on predetermined conditions using the collected information related to preference channels and stores information related to the result of analysis in an analysis result database 223-3. The report creation control module part 222-3 creates an audience rating report in a predetermined report format using information related to the analyzed audience rating that is stored in the analysis result database 223-3, stores the audience rating report in a report database 223-4 and controls the communication module unit 221 so that the audience rating report is transmitted to a client for an audience rating survey on-line via the network 200.

The audience analysis control module 222-2 may be designed to independently analyze, in particular, an advertising rating, and separately collects only advertising broadcasting at a time for received preference channel information, adds audience ratings of the collected advertising broadcasting and stores the audience ratings in the analysis result database 223-3.

The database 223 includes a member database 223-1, the collection information database 223-2, the analysis result database 223-3, and the report database 223-4.

Information related to registered members is stored in the member database 223-1, personal information of a participant or client of an audience rating survey is stored in the member database 223-1, information related to the preference channels that is collected on-line is stored in the collection information database 223-2, information related to the result of audience ratings that is analyzed on predetermined conditions, in particular, information related to audience ratings of advertising broadcasting, is stored in the analysis result database 223-3, and information related to the audience rating report in which the analyzed information related to the result of audience ratings is edited in a document format according to a predetermined report format, is stored in the report database 223-4.

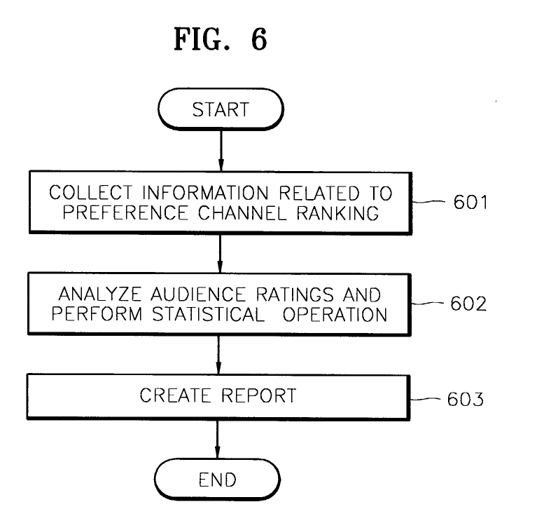

Hereinafter, the audience rating survey server 220 makes an audience rating survey by performing the following steps shown in FIG. 6.

In step 601, the audience rating survey server 220 collects information related to preference channels according to day and time from the preference channel information table that is stored in the memory 109 of TVs that are connected to the network 200 by the data collection control module part 222-1, and stores the information in the collection information database 223-2.

In step 602, the audience rating analysis control module part 222-2 analyzes audience ratings and performs a statistical operation using the information related to the preference channels that is stored in the collection information database 223-2, and stores the result of analysis in the analysis result database 223-3. In particular, the audience rating analysis control module part 222-2 classifies broadcasting programs and advertising broadcasting that are included at a preference channel time, analyzes audience ratings, performs a statistical operation, and then stores each information related to the result of analysis in the analysis result database 223-3.

In step 603, the report creation control module part 222-3 creates an audience rating report of broadcasting programs and advertising broadcasting using the analyzed information related to statistics of audience ratings that is stored in the analysis result database 223-3 and stores the report in the report database 223-4.

In this manner, an audience rating survey can be accurately made using information related to preference channels on-line.

As described above, according to the present invention, a user checks information related to preference channels according to day and time, registers the information according to rankings of the preference channels, uses the registered information related to preference channels when selecting channels, and makes an on-line audience rating survey of the registered information related to preference channels, thereby the user can easily search for a desired channel. In addition, preference channels are searched for immediately when turning on a TV, thereby the most preferred channel is automatically selected, and it is convenient to use, and the user collects information related to channels according to time on-line and makes an audience rating survey, thereby accurate audience ratings can be acquired. In particular, audience ratings of advertising can be accurately determined, thereby the result of the audience rating survey can be used as a marketing data.

The present invention can be implemented by method, apparatus, and system. When the present invention is implemented by software units, elements of the present invention are code segments for performing essential works. A program or code segments may be stored in processor readable media or may be transmitted via computer data signals that are combined with carrier waves in transmission media or a communication network. The processor readable media includes a medium for storing or transmitting information such as an electronic circuit, a semiconductor memory device, a ROM, a flash memory, an erasable ROM (EROM), a floppy disc, an optical disc, a hard disc, an optical fabric medium, and a radio frequency (RF) network. The computer data signals include all signals that can be transmitted on a medium such as an electronic network channel, an optical fiber, air, an electronic field, and a RF network.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. An apparatus for controlling preference channels, the apparatus comprising:
a timer circuit for performing an operation on information related to current day and time and outputting the information;
a memory for storing a preference channel information table that is totaled according to day and time; and
a controlling portion for classifying information related to the number of selected and viewed channels and information related to the number of preference channels based on output information of the timer circuit according to day and time, adding these information to channel points of a corresponding channel number of the preference channel information table that is stored in the memory, determining the ranking of preference channel numbers corresponding to values that are added according to day and time and performing a predetermined process of controlling channels using information related to the ranking of the preference channel numbers that is stored in the preference channel information table of the memory.

2. The apparatus of claim 1, further comprising a communication connection controlling portion for transmitting and receiving information related to the number of preference channels that is stored in the preference channel information table of the memory, via a communication line.

3. The apparatus of claim 1, wherein the controlling portion adds only information related to the number of channels that are selected and viewed consecutively without change for more than a predetermined critical time to the preference channel information table.

4. The apparatus of claim 3, wherein the predetermined critical time of the controlling portion can be set and input by a user and is determined by a default in a case where the predetermined critical time is not input by the user.

5. The apparatus of claim 1, wherein only information related to the number of preference channels having a predetermined ranking according to day and time is stored in the preference channel information table.

6. The apparatus of claim 1, wherein the predetermined process of controlling channels includes a process of reading information related to the number of a channel having an uppermost ranking at a current day and time from the preference channel information table on the basis of information related to the current day and time of the timer circuit and automatically selecting the read channel number in a case where a POWER ON command is input by the user.

7. The apparatus of claim 1, wherein the predetermined process of controlling channels includes a process of reading information related to the number of channels having predetermined rankings from information related to the number of a channel having an uppermost ranking at a current day and time from the preference channel information table on the basis of information related to the current day and time of the timer circuit and outputting the read information related to the number of channels according to a predetermined on screen display (OSD) specification in a case where a predetermined key for searching for preference channels is input by the user.

8. The apparatus of claim 7, wherein the predetermined OSD specification includes at least information related to time, ranking, the number of channels, and programs thereof.

9. The apparatus of claim 7, wherein the predetermined process of controlling channels includes a process of automatically selecting the number of a channel having the uppermost ranking in a case where the predetermined key for searching for preference channels is input by the user.

10. The apparatus of claim 9, wherein after the predetermined key for searching for preference channels is input by the user, a received channel is sequentially moved to an upper preference channel when an UP key is input by the user, and the received channel is sequentially moved to a lower preference channel when a DOWN key is input by the user.

11. The apparatus of claim 1, wherein the communication connection controlling portion allows the user to connect or disconnect external transmitting and receiving data.

12. A method for controlling preference channels, the method comprising:
(a) performing an operation on information related to a current day and time after channels are selected, and determining whether a same channel is maintained consecutively for more than a critical time;
(b) adding up a unit point to points of preference of selected channels at the current day and time from a preference channel information table in which points of channel preference of the number of a viewed channel according to day and time are stored in a case where the same channel is maintained consecutively for more than the critical time as a result of the determination in step (a);
(c) determining rankings of the number of preference channels according to the added up preference points; and
(d) transmitting and receiving data having determined rankings of the preference channel numbers via an external communication network.

13. The method of claim 12, wherein the critical time can be set and input by a user and is determined by a default in a case where the critical time is not input by the user.

14. The method of claim 12, further comprising reading information related to the number of a channel having an uppermost ranking at the current day and time from the preference channel information table by analyzing information related to the current day and time and automatically selecting the read channel number in a case where a POWER ON command is input by the user.

15. The method of claim 12, further comprising reading information related to the number of channels having predetermined rankings from information related to the number of a channel having an uppermost ranking at the current day and time from the preference channel information table on the basis of information related to the current day and time and outputting the read information related to the number of channels according to a predetermined on screen display (OSD) specification in a case where a predetermined key for searching for preference channels is input by the user.

16. The method of claim 15, wherein the predetermined OSD specification includes at least information related to time, ranking, the number of channels, and programs thereof.

17. The method of claim 15, further comprising automatically selecting the number of a channel having the uppermost ranking in a case where the predetermined key for searching for preference channels is input by the user.

18. The method of claim 17, wherein after the predetermined key for searching for preference channels is input by the user, a received channel is sequentially moved to an upper preference channel when an UP key is input by the user, and the received channel is sequentially moved to a lower preference channel when a DOWN key is input by the user.

19. The method of claim 12, wherein external transmitting and receiving data is connected or disconnected by the user.

20. An audience rating survey system, the system comprising:
a communication module unit for being connected to a network with an apparatus for controlling preference channels which performs a predetermined process of controlling channels and performing data communication;
a database for storing information related to members, preference channels, the result of analysis of audience ratings, and an audience rating report, which is collected through data communication; and
a control module unit for controlling the communication module unit and the database, collecting information related to preference channels according to day and time from TVs that are connected to the network, analyzing audience ratings using the collected information related to preference channels and performing a process of creating an audience rating report using the analyzed information related to audience ratings.

21. The system of claim 20, wherein the control module unit classifies broadcasting programs and advertising broadcasting that are included at a corresponding time viewed by a user, analyzes audience ratings and independently creates analyzed audience ratings of the broadcasting programs and the advertising broadcasting.

22. The system of claim 20, wherein the information related to preference channels is totaled information related to channels that are viewed according to day and time.

23. A method for making an audience rating survey, the method comprising:
(a) performing data communication with TVs that are connected to a network and collecting information related to preference channels;
(b) analyzing the information related to preference channels that is collected in the step (a) and performing audience rating evaluation according to day and time on the basis of statistics; and
(c) creating an audience rating report using the result of the audience rating evaluation that is performed in the step (b).

24. The method of claim 23, wherein the audience rating evaluation according to time in the step (b) is performed by classifying broadcasting programs and advertising broadcasting that are included at a corresponding time viewed by a user and independently evaluating the audience ratings of the broadcasting programs and the advertising broadcasting.
